(19) United States
(12) Patent Application Publication
(10) Pub. No.: US 2019/0049930 A1
(43) Pub. Date: Feb. 14, 2019

(54) SMART SOLENOID VALVE AND METHOD, SYSTEM, SOFTWARE, USER INTERFACE THEREOF

(71) Applicant: ODE S.R.L,., Colico (LC) (IT)

(72) Inventors: Lorenzo ROSSANO, Novate Mezzola (IT); Massimiliano PUCCI, Milano (IT); Alessio GUERCI, Bellano (IT)

(73) Assignee: ODE S.r.l., Colico (LC) (IT)

(21) Appl. No.: 16/075,823

(22) PCT Filed: Feb. 7, 2017
(86) PCT No.: PCT/IB2017/000090

§ 371 Date: Aug. 6, 2018

(30) Foreign Application Priority Data
Feb. 8, 2016 (IT) UB2016A000564
Jun. 16, 2016 (IT) UA2016A004454

(51) Int. Cl. G05B 19/418; F16K 37/00; G05B 15/02

(52) U.S. Cl. CPC G05B 19/4185; F16K 31/06; G05B 15/02; F16K 37/0083

(57) ABSTRACT

Smart solenoid valve equipped with a communication and control kit comprising a wireless communication system as well as a PLC capable of controlling a plurality of system components, management and control method, software and user interface thereof for the management of said plurality of components controlled, in turn, by the smart solenoid valve.

This invention regards a smart solenoid valve, operating method, system to which it belongs, software that manages and controls it and user interface thereof wherethrough it is managed and controlled by the operator.

It is known that a solenoid valve is essentially a valve that acts on the opening/closing, or choking, if necessary, of the fluid flow going through it, by means of an actuator, which, in the case of a solenoid valve, is of electromagnetic type. Generally, such actuator consists of a solenoid through which the running of a controlled current generates an electromagnetic field which attracts or repels some elements of polarized ferromagnetic materials, thus inducing the actuation of the solenoid valve on the flow to be opened/closed, or, if necessary, choked.

The art also provides solenoid valves, generally within the industry sector, equipped with a wireless kit for their wireless control, thus having no cables for connecting the, solenoid valve to the network, for example, with the system master PLC (or a controller for industry specialized in the management or control of the industrial processes). Therefore, in such cases, by connecting to the solenoid valve equipped with a wireless kit, through a data processing system, the operator is able to control the valve opening, closing, or choking, in order to best manage and optimize the fluid flow through said valve. Clearly, in addition to being performed manually by the operator, said control can be implemented on a master system PLC, or on an automatic operating software, programmable according to the technical requirements of the system, which automatically manages the operation of the solenoid valve equipped with said kit, via a wireless connection.

The advantages of management through a master system PLC of solenoid valves controlled via a wireless network are known, because the absence of connection cables to the main engineering system avoids the risk of damages and deterioration of the cables, resulting in system and valve malfunctioning, in addition to reducing the complexity of plant engineering during the implementation of wiring, as a result of the necessity to connect all the shut off/control members and actuators to each other.

A further advantage deriving from the replacement of the classic connection cable for controlling said shut off components, through the use of the aforementioned wireless systems, is the possibility of enabling operation of the systems controlled via a wireless connection in environments that envisage a separation from the surrounding environment (for example, EXAT explosive atmospheres) or in any case, generally, environments that are physically separated from the surrounding environment, for example, via a physical obstacle. Such obstacles would have to be physically crossed by the cable, or bypassed by the cable for operating such system components, if they were not equipped with a wireless communication system.

Therefore, the known art, with particular reference to solenoid valves, even if equipped with a kit for their operation via a wireless network, presents serious drawbacks deriving from the fact that each solenoid valve, even if it is wireless, nevertheless remains an essentially passive technical node of the system, thus passively undergoing the external management and operational commands thereof through a unidirectional communication flow, or rather, one moving only towards the solenoid valve, whether originated manually by the operator, or by a general master system PLC for the entire system, or by a local PLC system, in turn referable to a master system PLC, or by a Numerical Control (NC), or by a generally operated system.

Therefore, the management system of the known solenoid valves may be limited only to control passive system nodes, and may provide, at most, for a system for diagnosing the operating status of the solenoid valve itself, but does not enable the relocation of the management of local subsystems downstream of said solenoid valve and controlled/operated by the valve itself.

Again, the wireless solenoid valves of the known art do not even allow the storage of the data received from other equipment/devices directly in communication with or directly connected to said solenoid valves in order to actuate a specific activity, for example, on the same solenoid valve, or on members connected downstream of the valve itself.

In fact, US2012/215488 describes a method and an equipment for setting up a test that would verify the potential partial closing/opening of a valve on the emergency closing/opening system. In particular, the operation of the equipment provides that it allows the wireless communication of operational commands to a valve by a remote operator, based on data regarding the operating status of the valve and sensors (in this particular case, for example, a pressure and flow sensor, no other actuator is provided) applied to the valve work line, but it does NOT provide for the possibility to issue operational commands remotely by means of the valve to the same sensors, or to any actuators connectable to the solenoid valve, and not necessarily involved with the same valve work line. Therefore, in the equipment described, the communication flows from the sensors to the solenoid valve are not bidirectional, but unidirectional, as the valve ONLY receives data from the sensors and does NOT send data/commands to the sensors (compare paragraphs 32, 34).

Moreover, the device enabling wireless communication is not configured to enable its application on any solenoid valve for converting it from a normal solenoid valve to a wirelessly controllable and operable solenoid valve. The document describes its specific application in a test to verify the choking, opening/closing of an emergency valve, but not a releasable system that could be applied to all solenoid valves, both on the market and already installed on the system, the effect of which needs more than a mere design activity.

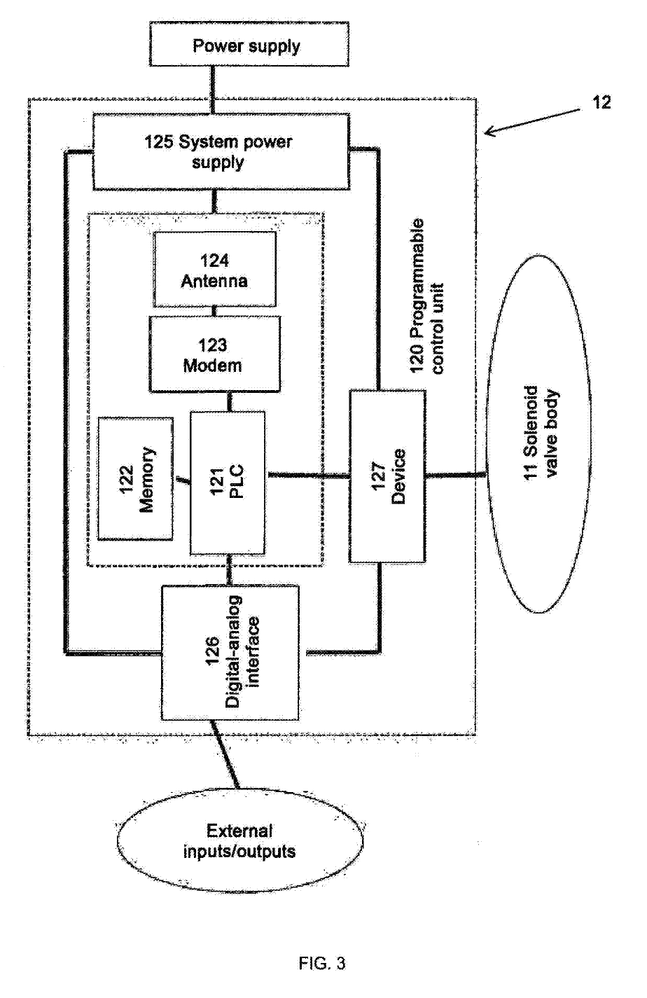

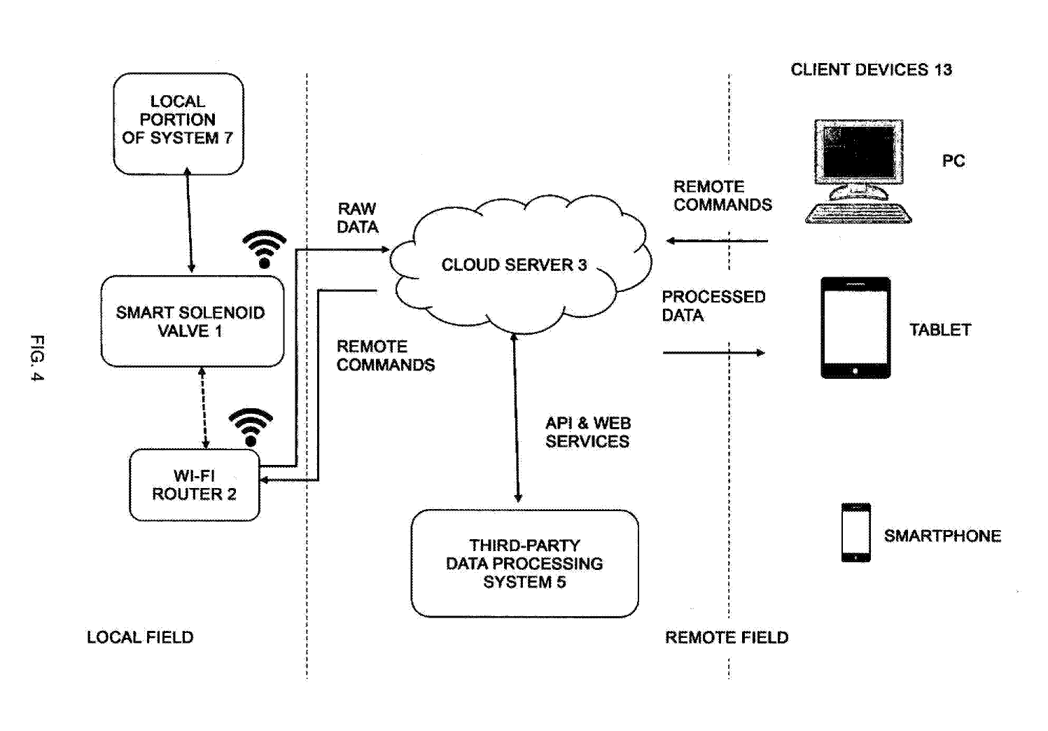

US2011/146805 describes a system for the distribution of domestic drinking water in which the operation of one or more, solenoid valves (12, 13, 14), of a pressure sensor (20) and of a flow sensor (19) is operated by a PLC (compare FIG. 3), BUT the solenoid valve does not actively operate these sensors, nor is there any mention of a removable wireless kit.

The literature review by G. Sathishkumar ET AL “Real time PLC based control systems, using wireless sensor network”, International Journal of Advanced Technology in Engineering and Science, Mar. 1, 2015, pages 2348-7550 and the attachment thereto also describe a system where the solenoid valve does NOT actively operate the existing sensors, and where it does NOT provide for a removable wireless kit.

Even documents CN204256460 U and WO2007/024894 do NOT describe solenoid valves capable of actively operating sensors/actuators, or other components and do NOT describe removable wireless kits.

The smart solenoid valve, subject of the invention, is equipped with a wireless communication kit capable of actively communicating with the devices/equipment connected to it, and controlling in turn the operation of said devices/equipment, as well as the method for remotely operating and controlling it, the software and application for mobile devices implementing the method, and the user interface through which it is possible to control, manage and operate the smart solenoid valve, and, if necessary, the local portion of the system connected to said smart solenoid valve.

It is a further object of the present invention to control, particularly within the field of industry, plant subsystems downstream of a physical obstacle not crossable by cables or, in areas with difficult or limited access for human beings for safety reasons.

It is another object of the invention to obtain a smart solenoid valve capable of storing data and processing said data in order to carry out certain activities on devices and equipment connected downstream of the solenoid valve subject of the invention.

It is a further object of the present invention to manage, control, and implement a subsystem governed by the smart solenoid valve subject of the invention, manageable by the operator by local and remote control.

It is a further object of the present invention to implement a system for locally and/or remotely controlling arid managing the smart solenoid valve in real time.

It is still a further object of the present invention to obtain a conversion kit for implementing management, communication and control of the smart solenoid valve that is easily and potentially associable/releasable with/from the known solenoid valves with regard to the requirements of maintenance or conversion of pre-existing solenoid valves, said kit being reasonably priced and easy to implement.

It is a further object of the invention to be able to obtain a system for managing and controlling the smart solenoid valve and the plant subsystem managed by the valve that would enable to obtain complex diagnostics also processed through multiple-variable graphs of the operation of the solenoid valve itself or in addition to the subsystem managed by the solenoid valve, with the possibility of implementing such complex diagnostics locally or remotely on computer devices.

It is a further object of the present invention to obtain a solenoid valve, and a system for managing and controlling the valve and the installation subsystem connected downstream of said solenoid valve, which is reliable, safe, reasonably priced, perfectly implementable and potentially configurable on any industrial system.

It is a further object of the present invention to obtain a system that provides devices capable of storing data coming from the smart solenoid valve and processing it in order to remotely actuate certain activities on the smart solenoid valve and/or on devices and equipment, or components generally connected downstream of the smart solenoid valve.

It is another object of the present invention to obtain a software application for mobile devices such as smartphones and/or tablets, compatible with common operating systems of such mobile devices, in order to remotely control and manage the smart solenoid valve and the local plant subsystem controllable and manageable by said valve.

It is a further object of the present invention to implement a particularly efficient method for performing preventive maintenance on the solenoid valve, locally and remotely manageable and verifiable in real time by the operator.

It is a further object of the present invention to obtain a user interface that easily enables to remotely manage and control the smart solenoid valve and the plant subsystem managed by the valve, which is capable of obtaining complex and detailed diagnostics of the operation of the solenoid valve itself, or in addition to the subsystem operated by the solenoid valve, as well as displaying the data regarding the preventive maintenance of the smart solenoid valve, which is easily accessible to the operator.

These and other objects are carried out in accordance with the present invention, which describes a solenoid valve equipped with a communication and control kit comprising a wireless communication system, as well as a PLC capable of controlling a plurality of plant components and a memory capable of storing the input and output data of said plurality of components managed by said smart solenoid valve.

In a particularly advantageous manner, the solenoid valve subject of the present invention is capable of actively controlling and managing the operation of actuators/sensors/devices/equipment, and therefore components in general, and if necessary, other smart solenoid valves, also through the processing of data deriving from the components connected to said valve, thus creating a local plant subsystem managed directly by the smart solenoid valve subject of the invention.

The wireless communication system integrated in the subject matter of the present invention may be, according to a listing merely provided by way of an example, and not limitation, of the WLAN industrial technology type (802.11, a, b, g, h, n), or any other wireless technology supported by the PLC hardware installed on the control and management kit of the smart solenoid valve subject of the invention.

The interface system with the operator of the control and management system of the smart solenoid valve object of this invention may be, according to a listing, merely provided by way of an example, and not limitation, a system computer device, a master system PLC, a local PLC, or a local NC.

The control and management system of the smart solenoid valve object of this invention may also provide for a printed circuit board for digital or analog signal input/output, or both, in order to cover the smart solenoid valve and enable it to interact with the most widely used sensor systems, actuators, devices, existing equipment, as well as additional storage units or other units also integrated, if necessary, in the programmable control unit, which will be described, and which may be further configured in order for smart solenoid valve to be programmable by a computer device to which it is connected.

The kit for converting the solenoid valve object of this invention may also provide for a printed circuit board for digital/analog signal input/output, or both, in order to cover the smart solenoid valve and to enable it to interact with known sensor systems, actuators, equipment, as well as with further smart solenoid valves, and provides for physical characteristics that enable it to be associated with and released from the solenoid valve body, the latter technical characteristic not being essential.

These and further advantages obtained as a result of the smart solenoid valve, the smart solenoid valve management system, and the method for remotely managing and controlling a smart solenoid valve, the software and application for mobile devices implementing the method, as well as the user interface described by this invention, will be described herein and below in the attached figures, in which:

FIG. 1 shows the smart solenoid valve subject of the invention;

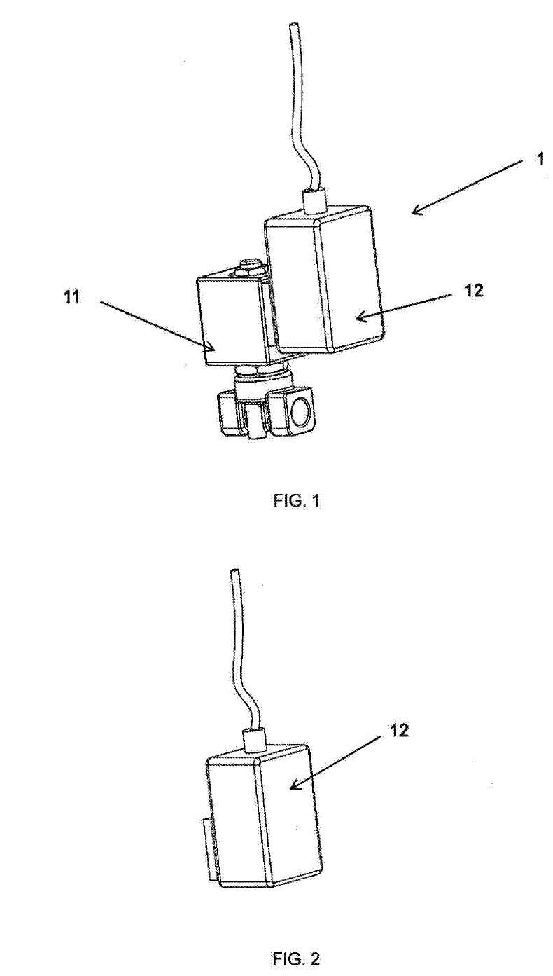

FIG. 2 shows the communication and control kit disassembled from the body of the smart solenoid valve subject of the invention;

FIG. 3 shows a technical-functional block diagram of the communication and control kit of the smart solenoid valve subject of the invention;

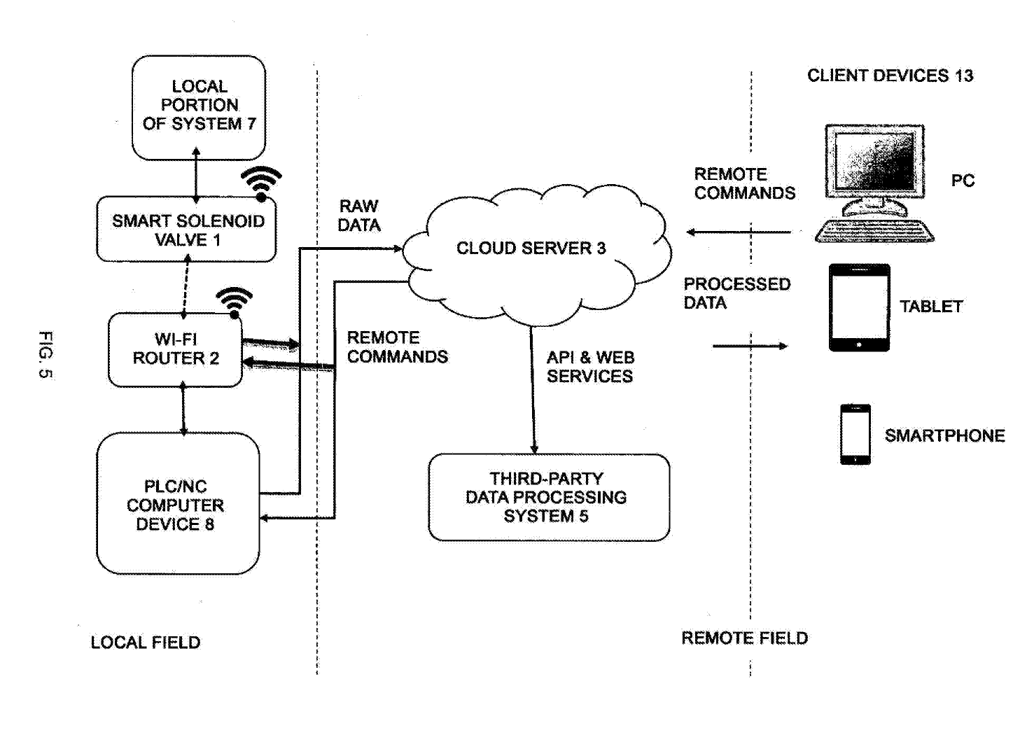

FIG. 4 shows a service drawing of the remote management and control system of the smart solenoid valve, which implements the method subject of the invention according to a preferred embodiment;

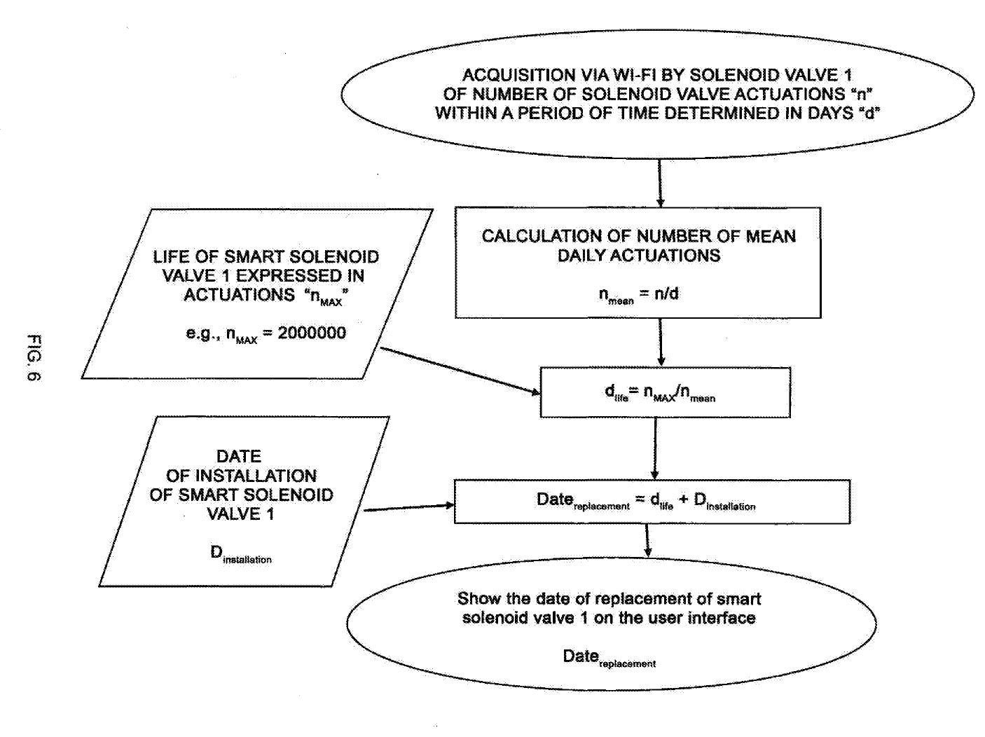

FIG. 5 shows a variation of the service drawing of the remote management and control system of the smart solenoid valve, which implements the method subject of the invention according to a variation of embodiment;

FIG. 6 shows a flow diagram of the steps of the method for processing the preventive maintenance data;

FIG. 1 shows a smart solenoid valve 1 according to the invention comprising in turn a solenoid valve body 11 and a communication and control kit 12, the latter capable of establishing communication between the smart solenoid valve 1 and the subsystem of actuators-devices-equipment, and therefore components C, generally connected to it via a network and, consisting of a local portion of the system 7, managed by the aforesaid smart solenoid valve. In addition, said communication and control kit 12 is capable of actuating, operating and controlling a part or ail said components C, or any other smart solenoid valves also belonging to said local portion of the system 7 operated by said smart solenoid valve 1, thus configuring bidirectional data communication flows.

The communication and control kit 12 is configurable, a non-essential feature, so that it can be functionally associable/releasable with/from said solenoid valve body 11, depending, on the technical requirements of the system and of the local portion of system 7 operated by said smart solenoid valve 1, both during, the commissioning and during any potential supplementary/routine maintenance operations or plant extension-reduction operations on said local portion of system 7.

FIG. 2 shows the communication and control kit 12 disassembled from the solenoid valve body 11. Said communication and control kit 12 is configurable so that it can be associated, or not, with any known solenoid valve body 11. Therefore, in the event of technical-functional assembly of said communication and control kit 12 to a solenoid valve body 11, the smart solenoid valve 1 subject of the invention is obtainable, capable not only of being operated passively by, for example, the PLC/NC system computer device 8, but also operating a local portion of the system 7 comprising one or more components C. This latter innovative feature, which enables a technical-functional assembly-disassembly of the communication and control kit 12 on/from the solenoid valve body 11, enables extensive versatility of technical-functional implementation, even of pre-existing systems by making use of the smart solenoid valve 1 subject of the invention. Therefore, the conversion kit of the solenoid valves subject of the invention consists of the communication and control kit 12 adapted to be technically-functionally connected to the solenoid valve body<11 of a known solenoid valve by means of a device 127 which transfers the operational commands of the PLC 121 to the solenoid valve body 11 (see FIG. 3), and, through a suitable physical link, and also through suitable known electrical and functional connections not shown in the Figures.

FIG. 3 shows a technical-functional block diagram of the communication and control kit 12 of the smart solenoid valve 1 subject of the invention, according to a preferred embodiment. Said communication and control kit 12 comprises a programmable control unit 120 equipped with a Programmable Logic Controller (PLC) 121, in the case of a preferred embodiment, a PLC 121 programmable directly on the spot by the operator through a programmable development environment, said PLC 121 being connected to a support and back up memory 122 for data derivable from the communication flow in the local and/or remote field, a modem 123 for wireless communication through an appropriate antenna 124 of said communication and control kit 12, for example with the PLC/NC system computer device 8 through a suitable IP (Internet Protocol) address which enables the univocal enumeration of the smart solenoid valve 1 and its connection to the company LAN network. Programming of the development environment loaded in the memory 122 produces an operating software that comprises code portions which implement a method for controlling, operating and monitoring the operation of a local portion of the system 7, comprising one or more components C connected to said smart solenoid valve 1, all equipment generally contained within a local field, as described below.

As stated before, the PLC 121 is configured to be also programmable on the spot by the operator, and is thus capable of executing specific programs according to the plant engineering requirements and constraints of the place, or, at any time once the installation of the solenoid valve has taken place according to the customer's specifications.

The programmable control unit 120 also provides for a power supply system 125 for said communication and control kit 12, a digital-analog interface 126 connected in turn to the micro-controller 121. The digital-analog interface 126 enables connection of input (for example, reading the signals coming, from the local field in the vicinity of the solenoid valve, <such as pressure, temperature, capacity, level, etc.) and output connectors (for example, reading the indications of light signaling, motors, relays, other solenoid valves, or other systems) for the part making up the local portion of the system 7 operated by the smart solenoid valve subject of the invention.

Finally, the programmable control unit 120 provides for a device 127 for functionally actuate/deactivate the solenoid valve body 11, thus being capable of transferring the PLC 121 commands to the solenoid valve body 11 to which it is functionally linked.

Installed in the memory 122 of the PLC 121 of the smart solenoid valve 1 is a development environment that enables the programming of the PLC, i.e., the PLC 121, said computer product consisted of a development environment is in turn programmable by the operator on the spot, obtaining a software capable of managing,. in addition to the commands issued from outside (for example, from a PLC/NC system computer device 8), also the input data received through the digital-analog interface 126 coining from one or more sensors/actuators and/or devices/equipment and/or other smart solenoid valves or components C, generally making up the local portion of the system 7 controlled by said smart solenoid valve 1. Moreover, by means of the operating software, such PLC 121 enables the processing of said data also in light of data stored in the memory 122, control the actuation-deactivation-control-monitoring-management, and, therefore, the general operation of components C, generally making up the local portion of the system 7 operated by said smart solenoid valve 1. It should be noted that the PLC 121 is programmable depending on the specific technical requirements of the system and on the specific technical constraints of the local portion of the system 7 managed by the single smart solenoid valve 1 in order to enable the control, management and monitoring of operation, transmit data regarding the operating status of one or more components C of a local portion of the system 7 connected to said smart solenoid valve 1.

In particular, the programmable control unit 120 may consist of a SoC (System on Chip) type circuit board, which integrates big WiFi communication, and the TCP client Modbus stack with big/n 802.11 Wi-Fi wireless communication protocol with 2.4 GHz TCP/IP stack with WPA/WPA2 authentication support and WEP/TKIP/AES integrated cryptography for ensuring the safety of communication. Said digital-analog interface 126 may be configured to operate the following series of peripherals: no. 4 or more digital I/Os capable of controlling external systems (for example, indicator lights, relays, motors, and so on), and no. 4 or more analog inputs for reading and processing indications such as pressure, flow, temperature, level, etc., and no. 1 PWM output for controlling the coil of the smart solenoid valve 1 subject of the invention.

The communication and control kit 12 may also provide for no. 2 pushbuttons, one for managing the “Reset” via wireless communication and one for actuating the automatic mode which enables the wireless coupling of the solenoid valve via the support wireless network, and, no. 1 RGB high luminosity led for indicating the operating status of the smart solenoid valve 1. The programmable control unit 120 may also be configured as a TCP Modbus client.

It is now advantageous to define the local field as a system comprising a plurality of equipment, among which, the smart solenoid valve 1, one or more components C of one or more local portions of the system 7 connected to said smart solenoid valve 1, and a PLC/NC computer device 8, setting up a bidirectional communication flow between the smart solenoid valve 1 and components C of the local portion of the system 7, a Wi-fi router 2 and the PLC/NC computer device 8. Instead, the remote field is defined as a system, which also comprises a cloud server 3, a third-party computer system 5, and client devices 13, in addition to the local field.

It is specified, merely by way of an example, and not, limitation, that the management and control system of one or more smart solenoid valves 1 subject of the invention may include one or more components C which may in turn consist of actuators, sensors, devices, equipment, other smart solenoid valves 1, or components C in general, actively controlled by a smart solenoid valve 1 through the communication, and control kit 12 thereof, or it may also include several smart solenoid valves 1, each managing and controlling, in turn, one or more portions of the local system 7 through the appropriate communication and control kit. For example, a smart solenoid valve 1 may receive the temperature datum detected by a component C, called sensor1, and a pressure datum by a component C called sensor2, in addition to receiving data regarding the operating status of one or more further solenoid valves belonging to the local field, and, on the basis of these data, the PLC 121 may, by means of the operating software installed in the memory 122 of the communication and control kit 12 of the smart solenoid valve 1 subject of the invention, command the activity on component C, called actuator (for example, a hydraulic actuator), and it may further detect and receive the operating status of all the components C of the field system on the PLC/NC computer device 8, and consequently, on the user interface through the Wi-fi router 2 and the company LAN network. Once the data in the local field have been detected, the operator may in turn command, through said user interface, any activities on the smart solenoid valves 1 of the local field and/or on the components C of one or more local portions of system 7 connected to it. It is specified that in the example just described, the component C, called sensor1, the component C, called sensor2, and the component C called actuator comprise a local portion of the system 7. The operating software executed by the PLC 121 comprises code portions for the implementation of a method adapted to control, manage and monitor the operation of at least one component C of at least one local portion of system 7, connectable to said smart solenoid valve 1.

The PLC/NC computer device 8, operated and controlled in turn by an operator or by an, automatic management system, is connected to said, company LAN network.

As stated, the development environment of the smart solenoid valve 1 is programmable by an operator during installation and/or by the user through a computer device connectable to it in the local field, said computer device in which is installed an appropriate programming software capable of programming the development environment loaded in the memory 122 of the communication and control kit 12 of the smart solenoid valve 1 subject of the invention according to the technical system specifications and the technical requirements of the user. It is specified that said programming software may also be loaded on the PLC/NC computer device 8.

FIG. 4 shows now the service drawing of a remote management and control system of one or more smart solenoid valves 1 that implements the method subject of the invention. It is specified that FIG. 4 shows only one smart solenoid valve 1 to avoid overcrowding the drawing, by way of an example, however, as already stated, the system subject of the invention may provide for the existence of one or more smart solenoid valves 1 in the local field. Therefore, the system comprises one or more smart solenoid valves 1 located in the local field, each equipped with a communication and control kit 12. By means of the software installed inside it, said wireless communication and control kit, as already described, makes each smart solenoid valve 1 accessible by a Wi-fi router 2, also located in the local field, via a local LAN/WLAN network. Through the Internet connection, the Wi-fi router 2 enables the transmission of data, to a cloud server 3 located in the field defined as remote, from one or more smart solenoid valves 1 and, if necessary, of a local portion of the system 7 (comprising one or more components C) governed by the same smart solenoid valve 1, said cloud server 3 is configured, in turn, to transmit remote commands still via Internet, through the Wi-fi router 3, to the single smart solenoid valve 1. Uploaded in the solenoid, valve memory 122 is a software that enables the transmission of raw data representing the operating status of the smart solenoid valve 1, and if necessary, the local portion of the system 7 connected to it, towards the cloud server 3 (and if necessary, also to the PLC/NC computer device 8), and, consequently, to the client device 13, said software is further configured to enable the reception of remote commands from the client device 13 (and also from the PLC/NC computer device 8, if necessary) by means of the cloud server 3.

The cloud server 3 implements a software adapted to receive data from the single smart solenoid valve 1, analyzing it according to specific criteria, processing it, issuing remote commands to said smart solenoid valve 1 coming from a mobile device, such as a tablet or smartphone, or from a generic computer device, and therefore from client devices 13 in the remote field, capable of communicating with the cloud server 3 via the Internet through the known systems of univocal recognition between computer devices (see FIG. 4). The generic client device 13 can access the cloud server 3 once it has received authorization through its specific user access credentials.

The cloud server 3 is also capable of sending, to the client device 13, the data processed from the raw data deriving from the single smart solenoid valve 1, by means of the software installed on the same cloud server 3, in such a way that through the user interface on the client device 13 the user can analyze the data processed and may subsequently control the appropriate activities to the single smart solenoid valve 1 by means of suitable remote commands sent by the client device 13 to the cloud server 3, and then, from the cloud server 3 to the single smart solenoid valve 1. The cloud server 3 can then receive, for example, the ambient temperature datum detected by a temperature sensor connected to each smart solenoid valve 1, and for example can receive from the smart solenoid valve 1 warning signals indicating a failure in the solenoid, missing Wi-fi signal, supply voltage to the single smart solenoid valve 1 exceeding the allowed limits, and other data.

In the variant embodiment shown in FIG. 5, the raw data coming from the single smart solenoid valve 1 are sent to the cloud server 3 and also parallel to the PLC/NC computer device 8 in the local field, which can then implement the user interface, the technical characteristics of which have already been described (see FIG. 5).

It is pointed out that the cloud server 3, the client device 13, each smart solenoid valve 1, and, if necessary, the PLC/NC computer device 8, are capable of interfacing with a communication flow of bidirectional data, by means of the Wi-fi router and the Internet network.

The operating method of the system described provides for the following steps:
starting up on a client device 13 located externally with respect to the local field, a user interface to allow the operator to control and operate one or more smart solenoid valves 1 equipped with a wireless communication and control kit 12, equipped in turn with a Programmable Logic Controller 121 and a memory,
supplying to the user interface, via an Internet network, and through a Wi-fi router 2 and a cloud server 3, a communication flow of data representative of the operating status of the one or more smart solenoid valves 1 and/or one or more components C functionally connected to the said one or more smart solenoid valve 1,
sending the data representative of the operating status of one or more smart solenoid valve 1 and/or one or more components C to one or more PLC/NC computer devices 8, so that they may be integrated into a method for the preventive maintenance of the smart solenoid valve 1,
enabling the operator, through specific user access credentials, access to said user interface and control of the data representative of the operating status of said one or more smart solenoid valves 1 and/or one or more components C functionally connected to said smart solenoid valve 1;
enabling the operator, acting on the user interface, to send a communication flow of operational commands to said one or more, smart solenoid valve 1 via the cloud server 3,
starting up said user interface, if necessary, also on a PLC/NC computer device 8, which in turn implements the master system PLC and is located inside the local field, said user interface to enable the operator to control and manage said smart solenoid valve 1 from said PLC/NC computer device 8.

By means of the user interface, the user may also set'threshold values for the parameters monitored and managed by the software installed on the cloud server 3, and may also set the software for sending a warning SMS and/or e-mail in the event the parameters monitored by the software, and received by the one or more smart solenoid valves 1, exceed and/or are equal to and/or are lower than said threshold values set, depending on the parameters being monitored.

The operating method of the system described also provides for the following steps:
enabling the operator, by means of the user interface, to set threshold values for the parameters of the data representative of the operating status of one or more smart solenoid valves 1 and/or one or more components C functionally connected to said one or more smart solenoid valve 1,
sending a warning SMS and/or e-mail in the event the parameters being considered exceed and/or are equal to and/or are lower than said threshold values set.

The software installed on the cloud server 3 also enables to file and access, through the user interface, a historical report of data, which is in turn customizable according to the form in which it is represented, of the parameters monitored allowing, with such data, to obtain complex graphic analyses with one or more variables. It is also possible, through the user interface, to download the values of the historical report of data in suitable, widely known interchange file formats or spreadsheets to be used for future computer processing operations.

The operating method of the system described also provides for the following stages;
storing in the memory of a cloud server 3 a communication flow of data representative of the operating status of one or more smart solenoid valves 1,, creating a historical report, over time, of data representative of the operating status of the one or more smart solenoid valves 1 and/or one or more components C functionally connected to said one or more smart solenoid valves 1,
enabling the creation, through the user interface, of graphs with one or more variables, for processing complex analyses regarding the operating status of one or more smart solenoid valves 1 and/or one or more components C functionally connected to said one or more smart solenoid valve 1.

A further innovative feature of the software installed on the cloud server 3 of the system subject of the invention is the capability to implement a preventive maintenance software module, which enables to send a warning indicating the necessity for a maintenance intervention on the smart solenoid valve, via SMS or e-mail, or through a video message on the user interface, visible on a computer device, such as the PLC/NC computer device 8 or the client device 13. Said preventive maintenance software module implements a method, depicted in the flow diagram in FIG. 6, which comprises the following operational steps:
acquisition by one or more smart solenoid valves 1 of the datum regarding the number n of actuations of one or more smart solenoid valves 1 for a period of time defined days d;
calculation of the mean number nₘₑₐₙ datum of daily actuations defined as n/d;
calculation of the estimated life in days d_{life} of the one or more smart solenoid valves 1 object to monitoring, dividing the known datum of maximum number of actuations allowed nₘₐₓ for said smart solenoid valve 1 by the mean number nₘₑₐₙ of daily actuations;
calculation of the replacement date date_{replacement} of the one or more smart solenoid valves 10 determined by summing the estimated life in days dare to the installation date Dᵢₙₛₜₐₗₗₐₜᵢₒₙ of the one or more solenoid valves 1, which is known;
showing on the user interface the replacement date date_{replacement} of one or more smart solenoid valves 1.

Therefore, said communication and control kit 12 is configured to supply the data regarding the operating status of smart solenoid valve 1 and send it to one or more PLC/NC computer devices 8 and/or to a cloud server 3, so that they may be integrated into a method of preventive maintenance for the smart solenoid valve 1.

The user may also enable the connection and integration of a third-party data processing system 5 to the cloud server 3 through the use of API and Web services. Therefore, the final user may interface the information and data coming from the smart solenoid valve 1, and, consequently, from the software installed on the cloud server 3, with their own management system, to allow these to be processed by their own data processing systems. This feature of the software installed on the cloud server 3 ensures the maximum system flexibility and the maximum integration with third-party data processing systems.

The operating method of the system described herein further provides for the following steps:
enabling the user to integrate said communication flows of data and commands with a third-party data processing system 5 making use of API and Web services acting by means of the cloud server 3 and having previously entered the appropriate user credentials.

It is pointed out that, according to the variant shown in FIG. 5 (as already stated), which provides that the PLC/NC, computer device 8 existing locally receive information to/from each smart solenoid valve 1, and that it simultaneously repeats this data to the cloud server 3 through a Wi-Fi router 2, this enables the user to control and manage one or more smart solenoid valves 1 and a local portion, if any, of the system 7 connected to it, both by means of a PLC/NC computer device 8, and therefore locally, and also remotely through the client device 13, by means of the cloud server 3.

A software is installed on the cloud server 3, on the client device 13 and, if necessary, on the PLC/NC computer device 8, adapted to implement and enable the execution of the appropriate and relative stages of the method subject of the present invention, and adapted to enable the bidirectional communication flow between one or more smart solenoid valves 1, the cloud server 3, the client devices 13, and if necessary, the PLC/NC computer device 8.

In the memory 122 of the communication and control kit 12 of the one or more smart solenoid valves 1, as previously stated, a software is installed adapted to implement and enable the execution of the appropriate and relative steps of the method subject of the present invention, and adapted to enable bidirectional communication flow between one or more smart solenoid valves 1, the cloud server 3, the client device 13, and if necessary, the PLC/NC computer device 8.

The user interface, subject of the invention, which is started up and displayed on the client device 13 connected to the cloud server 3 and/or on the PLC/NC computer device 8, is capable of showing the user the data and/or historical report of data representative of the operating status of one or more smart solenoid valves 1 and/or one or more components C functionally connected to said solenoid valve consisting of a local portion of the system 7, in addition to showing graphs, if any, with one or more variables regarding the operating status of the one or more smart solenoid valves 1 and/or one or more components C functionally connected to said smart solenoid valve 1, consisting of a local portion of the system 7.

The user interface further provides the possibility of setting threshold values for the parameters of data representative of the operating status of the smart solenoid valve 1 and/or one or more components C functionally connected to said smart solenoid valve 1, and also sending a warning SMS and/or e-mail in the event the parameters under consideration exceed and/or are equal to and/or are lower than said threshold values set, also showing the user, if necessary, the replacement date date_{replacement} of the smart solenoid valve 1 calculated on the basis of the datum regarding the number n of actuations for a period of time determined in days d of the said smart solenoid valve 1, according to the steps of the method described, in order to enable the user to carry out preventive maintenance on said smart solenoid valve 1.

Finally, the user interface is configured to enable the user to send a communication flow of operational commands to said one or more smart solenoid, valves 1 and/or one or more components C functionally connected to said one or more smart solenoid valves 1, and is configured to receive data representative of the operating status of the smart solenoid valve 1, and if necessary, of a local portion of the system connected to it, for example data regarding pressure, local temperature, work cycle counter, humidity, flow data, but also data relative to sensors, actuators, other smart solenoid valves and components in general, consisting of the local portion of the system downstream of the one or more smart solenoid valves 1, managed and controlled by it.

The software application installed on the client device 13, or installable, if necessary, on a PLC/NC computer device 8 or on the cloud server 3, is also configured to provide some functionalities regarding the processes of reorganization of components.

The application software for the client devices 13, and in particular, for mobile devices, is developed and optimized for use in the most common and widely used mobile device operating systems, and it implements all the functional characteristics and software modules already described for the software installed on the, cloud server 3.

It should be noted that the use of a single smart solenoid valve 1, its possible control/management of one or more or no actuators A, its possible control/management, of one or more or no S sensors, or several of such devices, or still the possible control/management of one, or more or no other smart solenoid valves 1, or finally its possible control/management of one or more portions of the local system 7 falls within the inventive scope of the present invention.

The management and control of the management-control system of the smart solenoid valves subject of the invention also fall within the inventive scope of the present invention, even when implemented exclusively and directly within the local field through an appropriate computer device, and therefore, with or without a system PLC.

A further object of the present invention is the conversion kit for solenoid valves consisted of the management and control kit 12 associable with a solenoid valve body 11, in order to be able to manage and control it through the management and control system of the smart solenoid valves 1 subject of the invention.

Therefore, an object of the present invention is also the, use of a smart solenoid valve 1 as previously described, and integrated in a management and control system of said smart solenoid valve 1, as previously described, in any technical field, and consequently from the industrial field to the field of individual household appliances, operated locally and in the field system.

These are only some of the preferred and possible embodiments of the smart solenoid valve and the management control system of the smart solenoid valve, further variants where the elements making up the product/system may be, coupled/implemented in different ways, or may have alternative forms, which are nevertheless suitable for the purpose described by this invention, or materials of any kind or any modification whatsoever falling in any case within the scope described by this invention, are to be considered alternative embodiments to those preferred ones previously described, in which modifications and changes regarding, for example, the geometries chosen for the single movable and fixed elements, the materials adopted for each member and also the actuating system specifications may be made without departing from the scope of the protection of the present invention, as described in the claims attached hereto.

### LIST OF REFERENCE NUMBERS

smart, solenoid valve 1
solenoid valve body 11
communication and control kit 12
programmable control unit 120
PLC 121
memory 122
modem 123
antenna 124
feed system 125
digital-analog interface 126
device 127
local portion of system 7
components C
PLC/NC computer device 8
Wi-fi router 2
cloud server 3
client device 13,
third-party data processing system 5

1. A smart solenoid valve comprising:
a solenoid valve body,
a communication and control kit functionally connected to said solenoid valve body and configured to control operation of said solenoid valve body based on commands receivable via a wireless network from one or more programmable logic controller/numerical control (PLC/NC) computer devices,
wherein said communication and control kit comprises:
a PLC configured to execute programs implemented by a client through an integrated development environment and configured to execute an operating software loadable in a memory configured for data storage of an operating status of components of a local portion of a system, the components being connectable to said smart solenoid valve via a wireless connection or by a cable,
a modem, and
an antenna adapted to provide wireless communication between said smart solenoid valve and the one or more PLC/NC computer devices, and
a digital-analog interface being adapted to enable the connection and transfer of data communication flow of one or more components of said local portion of the system to said smart solenoid valve,
wherein said PLC further configured to process said received data to control, manage and monitor the operation of said at least one or more components of the local portion of the system and transmit the received data to the one or more PLC/NC computer devices,
wherein said communication and control kit being configured to enable bidirectional communication flows between smart solenoid valve and said at least one or more components and said one or more PLC/NC computer devices, and
wherein said communication and control kit is further configured to be functionally associable/releasable with/from the solenoid valve body depending on the first installation and/or maintenance and/or reconfiguration of solenoid valves already existing in smart solenoid valves and vice versa in the system in which said smart solenoid valve is installable.

2. The smart solenoid valve according to claim 1, wherein said communication and control kit functionally connected to said solenoid valve body is configured to supply the data of the operating status of the smart solenoid valve and send said data to one or more PLC/NC computer devices and/or a cloud server that integrate said data in a method of preventive maintenance of the smart solenoid valve.

3. A management and control system for a smart solenoid valve, the management and control system comprising:
a smart solenoid valve equipped with a communication and control kit comprising a programmable logic controller (PLC) and a memory for storing data communication flow of one or more components of a local portion of a system connected to said smart solenoid valve,
one or more programmable logic controller/numerical control (PLC/NC) computer devices,
a Wi-fi router configured to communicate with one or more smart solenoid valves to transfer the communication flow of data from said components of the local portion of the system to the smart solenoid valve, and from the smart solenoid valve to one or more PLC/NC computer devices, wherein said communication flow is bidirectional.

4. A method for remotely managing and controlling one or more smart solenoid valves according to claim 1, the method comprising the steps of:
starting up on a client device comprising memory and located in a remote field, a user interface to enable an operator to control and manage one or more smart solenoid valves located in a local field and equipped with a wireless communication and control kit comprising a PLC and a memory,
supplying the user interface, via Internet and by means of a Wi-fi router and a cloud server comprising memory, with a communication flow of data representative of an operating status of one or more smart solenoid valves and/or one or more components functionally connected to the one or more smart solenoid valves,
sending data representative of the operating status of one or more smart solenoid valves and/or one or more components to one or more programmable logic controller/numerical control (PLC/NC) computer devices that integrate said status into a method of preventive maintenance of the smart solenoid valve,
enabling the operator, through appropriate credentials, access to said user interface and control of the data representative of the operating status of said one or more smart solenoid valves and/or the one or more components functionally connected to the said one or more smart solenoid valves;
enabling the operator, by acting on the user interface, to send a communication flow of operational commands to the one or more smart solenoid valves and/or the one or more components functionally connected to the one or more smart solenoid valves through the cloud server.

5. The method according to claim 4 further comprising the step of:
enabling a user to integrate said communication flows of data and commands with a third-party data processing system through the use of application programming interface (API) and Web services acting by means of the cloud server and upon entering appropriate user credentials.

6. The method according to claim 4 further comprising the steps of:
storing in the memory of the cloud server the communication flow of data coming from the one or more smart solenoid valves, creating, over time, a historical report of data representative of the operating status of the one or more smart solenoid valves and/or the one or more components functionally connected to the said one or more smart solenoid valves, and
enabling the production, through the user interface, of graphs with one or more variables to work out complex analyses regarding the operating status of the one or more smart solenoid valves and/or the one or more components functionally connected to the one or more smart solenoid valves.

7. The method according to claim 4 further comprising the step of:
starting up the user interface on a client device consisting of a tablet or smartphone and/or a further PLC/NC computer device.

8. The method according to claim 4 further comprising the steps of:
enabling the operator, by means of the user interface, to set one or more threshold values for one or more parameters of the data representative of the operating status of the one or more smart solenoid valves and/or the one or more components functionally connected to the one or more smart solenoid valves,
sending a warning short message service (SMS) and/or e-mail in the event the parameters under consideration exceed and/or are equal to and/or are lower than the respective threshold values set.

9. The method according to claim 4 further comprising the steps of:
acquiring from the one or more smart solenoid valves datum regarding the number (n) of actuations for a period of time defined in days (d);
calculating a mean number datum (nₘₑₐₙ) of daily actuations defined by n/d;
calculating an estimated life in days (d_{life}) of the one or more smart solenoid valves, dividing a known datum of maximum actuations allowed (nₘₐₓ) for said one or more smart solenoid valves by the mean number (nₘₑₐₙ) of daily actuations;
calculating a replacement date (date_{replacement}) of the one or more smart solenoid valves defined by summing the estimated life in days (d_{life}) at an installation date (Dᵢₙₛₜₐₗₗₐₜᵢₒₙ) of the one or more smart solenoid valves, which is known.

10. The method according to claim 4 further comprising the step of:
loading software in the memory of the cloud server configured to communicate with a software loadable in the memory of the client device and with a software loadable in the memory of the communication and control kit of the one or more smart solenoid valves.

11. The method according to claim 4 further comprising the step of:
loading software in the memory of the communication and control kit of the one or more smart solenoid valves configured to communicate with a software loadable in the memory of the client device and with a software loadable in the cloud server.

12. The method according to claim 4 further comprising the step of:
loading software in the memory of the client device configured to communicate with a software loadable in the memory of the cloud server and with the software loadable in the memory of the communication and control kit of the one or more smart solenoid valves.

13. The method according to claim 10, wherein the cloud server is configured to execute the software.

14. A user interface bootable on a programmable logic controller/numerical control (PLC/NC) computer device located in a local field and/or on a client device located in a remote field, adapted to remotely manage and control one or more smart solenoid valves located in the local field and equipped with a wireless communication and a control-kit comprising a PLC and a memory, being configured to show a user data representative of an operating status of the one or more smart solenoid valves and/or one or more components functionally connected to the one or more smart solenoid valves and being configured to enable the user to send a communication flow of operational commands to the one or more smart solenoid valves and/or the one or more components functionally connected to the one or more smart solenoid valves.

15. The user interface according to claim 14 being configured to also show the user a historical report of the data representative of the operating status of the one or more smart solenoid valves and/or one or more components functionally connected to the one or more smart solenoid valves, and/or graphs with one or more variables regarding the operating status of the one or more smart solenoid valves and/or one or more components functionally connected to the one or more smart solenoid valves.

16. The user interface according to claim 14 being configured to also enable the user to set one or more threshold values for one or more parameters of the data representative of the operating status of the one or more smart solenoid valves and/or the one or more components functionally connected to the one or more smart solenoid valves, as well as to send a warning short message service (SMS) and/or e-mail in the event the parameters under consideration exceed and/or are equal to and/or are lower than the threshold values set.

17. The user interface according to claim 14 being configured to also show the user the replacement date (date_{replacement}) of the one or more smart solenoid valves, calculated on the basis of the datum regarding the number (n) of actuations for a period of time determined in days (d) of the one or more smart solenoid valves, in order to enable the user to program the preventive maintenance on the one or more smart solenoid valves.
